(19) United States
(12) Patent Application Publication
(10) Pub. No.: US 2015/0220796 A1
(43) Pub. Date: Aug. 6, 2015

(54) SIGN RECOGNITION APPARATUS AND METHOD FOR DETERMINING LEFT- OR RIGHT-HAND TRAFFIC DIVISION AND DISTANCE UNIT

(71) Applicant: DENSO CORPORATION, Kariya-city (JP)

(72) Inventor: KENSUKE YOKOI, Kariya-shi (JP)

(21) Appl. No.: 14/612,674

(22) Filed: Feb. 3, 2015

(30) Foreign Application Priority Data
Feb. 3, 2014 (JP) 2014-018660

(51) Int. Cl. G06K 9/00; B60R 1/00

(52) U.S. Cl. CPC G06K 9/00818; B60R 1/00

(57) ABSTRACT

A sign recognition apparatus is mounted to an own vehicle. An on-board imaging device is mounted to the own vehicle and captures an image of a periphery of the own vehicle. The sign recognition apparatus recognizes traffic signs including a no-passing sign from the image of the periphery of the own vehicle that has been captured by the on-board imaging device. Based on predetermined features of the no-passing sign included in the recognized traffic signs, the sign recognition apparatus determines a left- or right-hand traffic division used in an area in which the no-passing sign is set and a distance unit used in the traffic signs.

### CROSS-REFERENCE TO RELATED APPLICATION

This application is based on and claims the benefit of priority from Japanese Patent Application No. 2014-018660, filed Feb. 3, 2014, the disclosure of which is incorporated herein in its entirety by reference.

### BACKGROUND

1. Technical Field

The present invention relates to a technology for generating information required for various types of control operations based on recognition results of traffic signs.

2. Related Art

Conventionally, the following technology is known (refer to, for example, Japanese Patent No. 4604088). In the technology, a camera that is mounted in a vehicle captures an image of the vehicle periphery. A traffic sign is recognized from the image. Regulatory information is displayed based on the recognition result, to serve as a reminder. There has also been discussion in recent years for a more proactive use of traffic sign recognition results in caution alerts and vehicle control, in addition to reminders.

Traffic regulations and traffic signs differ depending on the country. Therefore, a problem occurs in that appropriate caution alerts and vehicle control cannot be actualized even when a traffic sign is recognized from an image, unless information on the left- or right-hand traffic division (i.e., that makes a distinction between left-hand traffic and right-hand traffic), the type of unit system used for the numbers displayed on the traffic sign (e.g., kilometers or miles), and the like can be determined.

Specifically, for example, the timing at which a caution alert is issued significantly differs depending on whether the numbers on the recognized traffic sign are in kilometers or miles. In addition, when the vehicle is changing vehicle lanes, the point of caution differs depending on whether the vehicle is moving to a passing lane or a cruising lane. However, the lane to which the vehicle is attempting to move cannot be accurately surmised unless the left- or right-hand traffic division is known.

### SUMMARY

It is thus desired to provide a technology for determining, from a traffic sign, a left- or right-hand traffic division, and a distance unit used in the region in which the traffic sign is set.

A first exemplary embodiment of the present disclosure provides a sign recognition apparatus that includes sign recognizing means and determining means. The sign recognizing means recognizes traffic signs including a no-passing sign from an image of a vehicle periphery that has been captured by an on-board imaging device. Based on predetermined features of the no-passing sign among the traffic signs recognized by the sign recognizing means, the determining means determines which of a left- or right-hand traffic division is used in an area in which the no-passing sign is set and a distance unit used in the traffic signs.

For example, the predetermined features of the no-passing sign may include a traversing line that traverses a traffic sign at an angle and a color of a pair of vehicle icons which are configured by: a left vehicle icon positioned on a left side in the traffic sign; and a right vehicle icon that is positioned on a right side in the traffic sign. The left- or right-hand traffic division makes a distinction between left-hand traffic and right-hand traffic. The distance unit may a kilometer unit system or a mile unit system.

In the sign recognition apparatus, if a traversing line that traverses a traffic sign at an angle is present in a traffic sign, the determining means may determine that the traffic division is left-hand traffic and the distance unit is a kilometer unit system. If a pair of vehicle icons, which are configured by: a left vehicle icon positioned on a left side in the traffic sign; and a right vehicle icon that is positioned on a right side in the traffic sign, are shown on the traffic sign and if the right vehicle icon of the pair of vehicle icons is colored red, the determining means may determine that the traffic division is left-hand traffic and the distance unit is a mile unit system. If the pair of vehicle icons are shown on the traffic sign and the left vehicle icon of the pair of vehicle icons is colored red, the determining means may determine that the traffic division is right-hand traffic and the distance unit is a kilometer unit system.

A second exemplary embodiment of the present disclosure provides a method for determining, based on features of a no-passing sign included in traffic signs extracted from an image, a left- or right-hand traffic division used in an area in which the image is captured and a distance unit used in the traffic signs. The method includes: i) if a traversing line that traverses the traffic sign at an angle is present in the traffic sign, determining that the left- or right-hand traffic division is left-hand traffic and the distance unit is a kilometer unit system; ii) if a pair of vehicle icons are shown on the traffic sign, the pair of vehicle icons being configured by: a left vehicle icon positioned on a left side in the traffic sign; and a right vehicle icon that is positioned on a right side in the traffic sign, and if the right vehicle icon of the pair of vehicle icons is colored red, determining that the traffic division is left-hand traffic and the distance unit is a mile unit system; and iii) if a pair of vehicle icons are shown on the traffic sign and if the left vehicle icon of the pair of vehicle icons is colored red, determining that the traffic division is right-hand traffic and the distance unit is a kilometer unit system.

According to the above-mentioned configuration, the left- or right-hand traffic division and the distance unit used in the region in which the traffic sign is set can be automatically determined based on the predetermined features of the traffic sign that has been recognized from an image. In addition, based on the determination result and the recognized traffic sign, the driver can be provided with appropriate driving assistance (such as a caution alert or vehicle control).

In addition to the above-described sign recognition apparatus, the present disclosure can be actualized by various aspects, such as a system that uses the sign recognition apparatus as a constituent element or a program for enabling a computer to function as the sign recognition apparatus.

### BRIEF DESCRIPTION OF THE DRAWINGS

In the accompanying drawings:

FIG. 1 is a block diagram of an overall configuration of a driving assistance system;

FIG. 2 is an explanatory diagram of a correspondence relationship among a no-passing sign, a left- or right-hand traffic division, and a distance unit used in each country; and

FIG. 3 is a flowchart of the details of a process performed by a sign identifying unit of FIG. 1.

### DESCRIPTION OF EMBODIMENTS

An embodiment to which the present disclosure is applied is hereinafter described with reference to the drawings.

### <Overall Configuration>

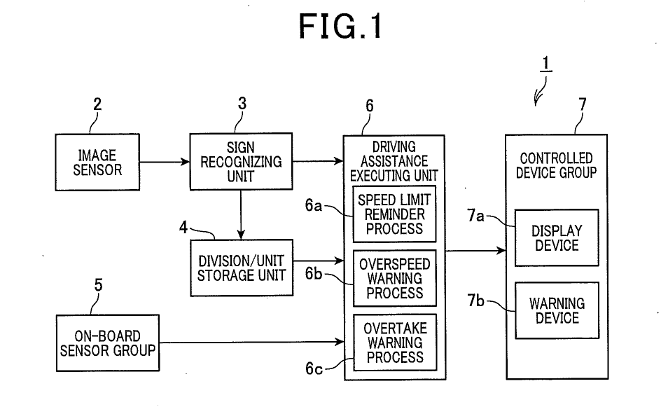

As shown in FIG. 1, a driving assistance system 1 to which the present disclosure is applied includes an image sensor (corresponding to an on-board imaging device) 2, a sign recognizing unit (corresponding to a sign recognition apparatus) 3, a division/unit storage unit 4, an on-board sensor group 5, a driving assistance executing unit 6, and a controlled device group 7.

The image sensor 2 is composed of a charge-coupled device (CCD) camera that is disposed inside a vehicle cabin near a rear-view mirror. The image sensor 2 is set so as to capture an image of the periphery of the own vehicle (at least the area ahead of the own vehicle). The CCD camera to be used as the image sensor 2 has the capability of identifying at least a red-colored portion.

The sign recognizing unit 3 recognizes a traffic sign that is captured in an image, based on the image captured by the image sensor 2. In addition, the sign recognizing unit 3 performs a sign recognition process (described hereafter). In the sign recognition process, the sign recognizing unit 3 determines, from the features of the recognized traffic sign, a left- or right-hand traffic division used in the region in which the vehicle is traveling (in other words, the region in which the recognized traffic sign is set) and a distance unit of numbers displayed on the traffic sign. The left- or right-hand traffic division makes a distinction between left-hand traffic and right-hand traffic. The distance unit may a kilometer unit system or a mile unit system.

The division/unit storage unit 4 is composed of a rewritable non-volatile memory. The division/unit storage unit 4 stores therein the left- or right-hand traffic division and distance unit determined by the sign recognizing unit 3. The on-board sensor group 5 is composed of various types of sensors that detect the behavior of the own vehicle.

The driving assistance executing unit 6 is composed of a known microcomputer. The driving assistance executing unit 6 runs various types of applications (predetermined application programs) for driving assistance by controlling the controlled device group 7, based on the recognition result of the traffic sign from the sign recognizing unit 3, the left- or right-hand traffic division and distance unit stored in the division/unit storage unit 4, and various types of information detected by the on-board sensor group 5.

The controlled device group 7 is composed of a plurality of on-board device. The on-board device includes at least a monitor (corresponding to a display device 7a) and a speaker (corresponding to a warning device 7b). The monitor displays various types of images. The speaker outputs warning sounds and guidance audio.

The applications that are run by the driving assistance executing unit 6 include, for example, a speed limit reminder process 6a, a speeding warning process 6b, and an overtake warning process 6c. Among these processes 6a to 6c, in the speed limit reminder process 6a, when a traffic sign that indicates a speed limit is recognized, the numerical value indicating the speed limit shown on the traffic sign is displayed on the monitor, together with the distance unit (or a speed unit identified from the distance unit) stored in the division/unit storage unit 4.

In the speeding warning process 6b, when the own vehicle exceeds, or is about to exceed, the speed limit for which the reminder has been issued through the speed limit reminder process, a warning sound or the like is generated through the speaker. In this speeding warning process 6b, the own vehicle speed and a threshold that is set based on the speed limit are compared. The magnitude of the threshold changes accordingly based on the distance unit stored in the division/unit storage unit 4.

In the overtake warning process 6c, when the own vehicle is attempting to change vehicle lanes, whether the own vehicle is attempting to enter a passing lane or a cruising lane is determined based on the left- or right-hand traffic division that is stored in the division/unit storage unit 4. When the own vehicle is attempting to enter the passing lane regardless of being in a no-passing zone, a warning sound or audio guidance is generated to prompt caution.

In other words, to enable the driving assistance executing unit 6 to correctly perform these processes, whether the unit of the numerical value shown on the traffic sign is kilometers or miles, whether the traffic lane used in the vicinity of the current position is right-hand traffic or left-hand traffic, and the like are required to be correctly recognized.

### <Division/Distance Unit>

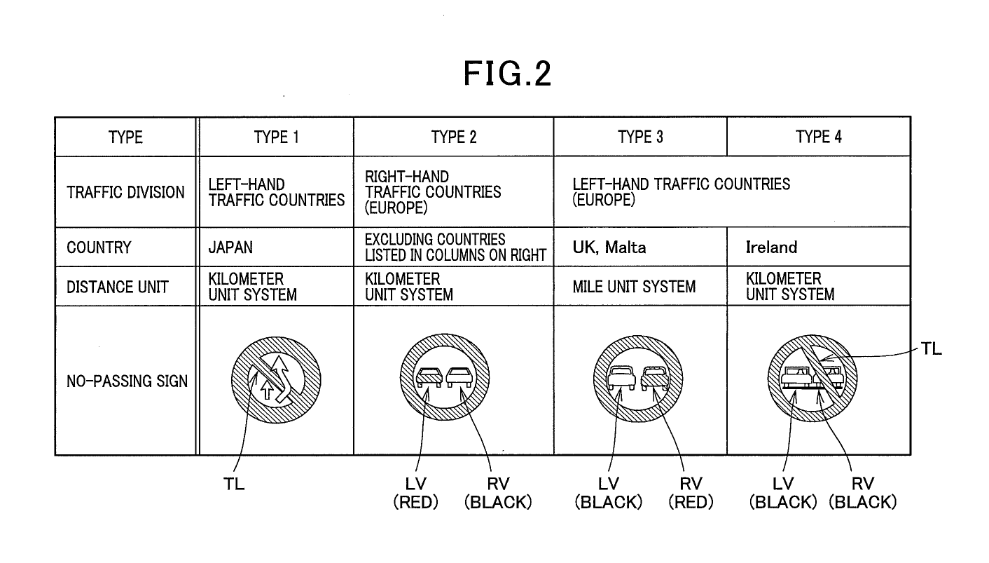

Here, FIG. 2 shows the relationship among the no-passing sign used in each country (e.g., Japan and European countries), the country using each no-passing sign, the left- or right-hand traffic division used in each country, and the distance unit of the numerical value shown on the traffic sign. The shaded portions in FIG. 2 are portions that are colored red. Based on the relationship of FIG. 2, the no-passing sign falls into four types as described below.

As shown in FIG. 2, Japan uses left-hand traffic for the left- or right-hand traffic division and kilometers for the distance unit. In addition, the no-passing sign shows a traversing line TL hat traverses the sign at an angle and a pair of arrows that bring to mind overtaking (this no-passing sign is classified into type 1 in FIG. 2).

Europe includes countries that use right-hand traffic and countries that use left-hand traffic for the left- or right-hand traffic division. Specifically, Great Britain, Malta, and Ireland use left-hand traffic. The remaining countries use right-hand traffic. The European countries that use right-hand traffic each use the kilometer unit system as the distance unit. The no-passing sign does not include a traversing line TL, and shows a pair of vehicle icons LV and RV, where LV denotes a left vehicle icon and RV denotes a right vehicle icon.

However, of the pair of vehicle icons LV and RV, the left vehicle icon LV is colored red and the right vehicle icon RV is colored black (this no-passing sign is classified into type 2 in FIG. 2).

On the other hand, among the European countries that use left-hand traffic, Great Britain and Malta use the mile unit system as the distance unit. The no-passing sign does not have a traversing line TL, and shows a pair of vehicle icons LV and RV. However, of the pair of vehicle icons LV and RV, the left vehicle icon LV is colored black and the right vehicle icon VI2 is colored red (this no-passing sign is classified into type 3 in FIG. 2).

In addition, among the European countries that use left-hand traffic, the remaining country, Ireland, uses the kilometer unit system as the distance unit. The no-passing sign shows a pair of vehicles LV and RV that are both colored black and a traversing line TL that traverses the sign at an angle so as to pass through the vehicle that is positioned on the right (this no-passing sign is classified into type 4 in FIG. 2).

### <Sign Recognition Process>

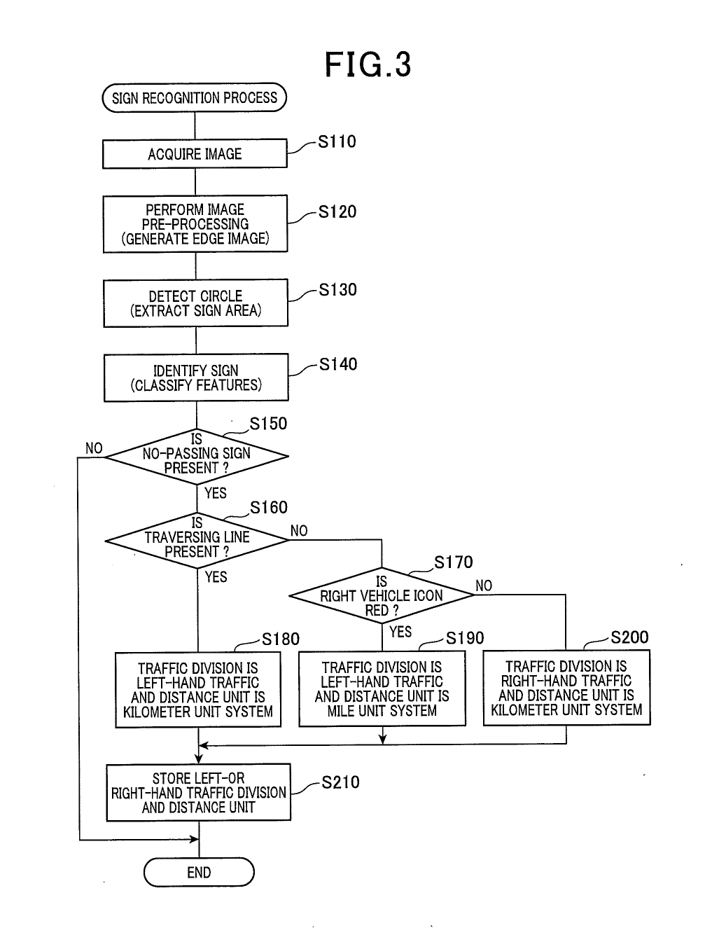

The sign recognition process performed by the sign recognizing unit 3 will be described with reference to FIG. 3. The sign recognizing unit 3 may be actualized by hardware, such as a logic circuit. Alternatively, at least a portion of the sign recognizing unit 3 may be actualized by software, or in other words, a process performed by a microcomputer.

The sign recognition process is periodically performed every certain amount of time that is set in advance, when the sign recognizing unit 3 is started.

When the sign recognition process is started, first, at step S110, the sign recognizing unit 3 acquires an image from the image sensor 2. At subsequent step S120, the sign recognizing unit 3 performs image pre-processing on the acquired image. Specifically, in image pre-processing, the sign recognizing unit 3 generates an edge image in which the contours of objects captured in the image are enhanced. At subsequent step S130, the sign recognizing unit 3 extracts an area in which an object that has a circular contour is captured, based on the edge image. The extracted area serves as a sign candidate area.

At subsequent step S140, for each of the sign candidate areas extracted at step S130, the sign recognizing unit 3 identifies the corresponding type of traffic sign. Here, the sign recognizing unit 3 identifies at least whether the traffic sign is a speed limit sign (a sign that shows the limit value within a red circle and that is common among the countries) or a no-passing sign (the four types 1 to 4 shown in FIG. 2).

The sign recognizing unit 3 actualizes identification by hierarchically using a linear discriminator configured by a support vector machine (SVM). When the sign is the speed limit sign, the linear discriminator also identifies the numerical value indicating the speed limit that is shown on the sign. When the sign is the no-passing sign, the linear discriminator also identifies whether or not a traversing line TL that traverses the sign at an angle is present on the sign. Furthermore, the linear discriminator identifies whether or not a pair of vehicle icons LV and RV are present on the sign. The linear discriminator identifies whether or not, of the pair of vehicle icons LV and RV, the right vehicle icon RV is red. The linear discriminator also identifies whether or not, of the pair of vehicle icons, the left vehicle icon LV is red.

The sign recognizing unit 3 then outputs, to the driving assistance executing unit 6, information indicating the type of traffic sign (in addition to the numerical value indicating the speed limit value when the traffic sign is the speed limit sign) that is the identification result.

At subsequent step S150, the sign recognizing unit 3 determines whether or not a no-passing sign is present based on the identification result at step S140. When determined that no no-passing sign has been identified (NO at step S150), the sign recognizing unit 3 temporarily ends the sign recognition process. Conversely, when determined that a no-passing sign has been identified (YES at step S150), the sign recognizing unit 3 proceeds to S160.

At step S160, the sign recognizing unit 3 determines whether or not a traversing line TL is present on the identified no-passing sign. When determined that a traversing line TL is present (YES at step S160), at step S180, the sign recognizing unit 3 determines that the left- or right-hand traffic division is left-hand traffic and the distance unit is the kilometer unit system (the identified no-passing sign corresponds to type 1 or 4 in FIG. 2). The sign recognizing unit 3 then proceeds to step S210. Conversely, when determined that a traversing line TL is not present (NO at step S160), the sign recognizing unit 3 proceeds to step S170.

At step S170, the sign recognizing unit 3 determines whether or not the right vehicle icon RV of the pair of vehicle icons LV and RV shown on the identified no-passing sign is red. When determined that the right vehicle icon is red (YES at step S170), at step S190, the sign recognizing unit 3 determines that the left- or right-hand traffic division is left-hand traffic and the distance unit is the mile unit system (the identified no-passing sign corresponds to type 3 in FIG. 2). The sign recognizing unit 3 then proceeds to step S210.

Conversely, when determined that the right vehicle icon is not red (NO at step S170), or in other words, the left vehicle icon LV is red in this case, at step S200, the sign recognizing unit 3 determines that the left- or right-hand traffic division is right-hand traffic and the distance unit is the kilometer unit system (the identified no-passing sign corresponds to type 2 in FIG. 2). The sign recognizing unit 3 then proceeds to step S210.

At step S210, the sign recognizing unit 3 stores the left- or right-hand traffic division and the distance unit determined at steps S180 to S200 in the division/unit storage unit 4 and temporarily ends the sign recognition process.

### <Effects>

As described above, in the driving assistance system 1, the left- or right-hand traffic division and distance unit used in the region in which the traffic sign is set are automatically determined, based on the features of the traffic sign that has been recognized from an image. Therefore, the driver can be provided with appropriate driving assistance (such as a caution alert or vehicle control) based on the determination result and the recognized traffic sign.

### Other Embodiments

An embodiment of the present disclosure is described above. However, the present disclosure is not limited to the above-described embodiment. It goes without saying that various aspects are possible.

(1) According to the above-described embodiment, as the linear discriminator used to identify the traffic sign, a linear discriminator composed of a support vector machine is used. However, the linear discriminator is not limited thereto. An arbitrary linear discriminator can be used.

(2) According to the above-described embodiment, a linear discriminator is used to identify the traffic sign. However, this is not limited thereto. For example, a technique such as template matching using templates of traffic signs may be used.

(3) According to the above-described embodiment, the monitor (display device) and the speaker (warning device) are used as the controlled device (controlled object) for the application run by the driving assistance executing unit 6. However, this is not limited thereto. For example, the controlled object may be device related to control of vehicle behavior, such as braking force or steering.

(4) According to the above-described embodiment, the no-passing sign used in Japan and European countries is described. Any no-passing sign used in any country other than Japan and European countries may be used, if it falls into any of the four types 1 to 4 as described above (see FIG. 2).

(5) Each constituent element of the present disclosure is conceptual and is not limited to the above-described embodiments. For example, functions provided by a single constituent element may be dispersed among a plurality of constituent elements. Alternatively, functions provided by a plurality of constituent elements may be integrated in a single constituent element. In addition, at least some of the configurations according to the above-described embodiments may be replaced with known configurations providing similar functions. In addition, at least some of the configurations according to an above-described embodiment may be added to or substituted for configurations according to another of the above-described embodiment.

What is claimed is:

1. A sign recognition apparatus comprising:
sign recognizing means that is mounted to an own vehicle and recognizes traffic signs including a no-passing sign from an image of a periphery of the own vehicle, the image being captured by an on-board imaging device that is mounted to the own vehicle; and
determining means that is mounted to the own vehicle and determines a left- or right-hand traffic division used in an area in which the no-passing sign is set and a distance unit used in the traffic signs, based on predetermined features of the no-passing sign included in the traffic signs recognized by the sign recognizing means.

2. The sign recognition apparatus according to claim 1, wherein
the determining means is configured to:
use, as the predetermined features of the no-passing sign, at least whether or not a traversing line that traverses the traffic sign at an angle is present in the traffic sign; and
determine that, if the traversing line is present, the left- or right-hand traffic division is left-hand traffic and the distance unit is a kilometer unit system.

3. The sign recognition apparatus according to claim 1, wherein
the determining means is configured to:
use, as the predetermined features of the no-passing sign, at least a color of a pair of vehicle icons are shown on the traffic sign, the pair of vehicle icons being configured by: a left vehicle icon positioned on a left side in the traffic sign; and a right vehicle icon that is positioned on a right side in the traffic sign;
determine that, if the right vehicle icon of the pair of vehicle icons is colored red, the left- or right-hand traffic division is left-hand traffic and the distance unit is a mile unit system; and
determine that, if the left vehicle icon of the pair of vehicle icons is colored red, the left- or right-hand traffic division is right-hand traffic and the distance unit is a kilometer unit system.

4. The sign recognition apparatus according to claim 2, wherein
the determining means is configured to:
use, as the predetermined features of the no-passing sign, at least a color of a pair of vehicle icons are shown on the traffic sign, the pair of vehicle icons being configured by: a left vehicle icon positioned on a left side in the traffic sign; and a right vehicle icon that is positioned on a right side in the traffic sign;
determine that, if the right vehicle icon of the pair of vehicle icons is colored red, the left- or right-hand traffic division is left-hand traffic and the distance unit is a mile unit system; and
determine that, if the left vehicle icon of the pair of vehicle icons is colored red, the left- or right-hand traffic division is right-hand traffic and the distance unit is a kilometer unit system.

5. A method for determining, based on features of a no-passing sign included in traffic signs extracted from an image, a left- or right-hand traffic division used in an area in which the image is captured and a distance unit used in the traffic signs, the method comprising:
if a traversing line that traverses the traffic sign at an angle is present in the traffic sign, determining that the left- or right-hand traffic division is left-hand traffic and the distance unit is a kilometer unit system;
if a pair of vehicle icons are shown on the traffic sign, the pair of vehicle icons being configured by: a left vehicle icon positioned on a left side in the traffic sign; and a right vehicle icon that is positioned on a right side in the traffic sign, and if the right vehicle icon of the pair of vehicle icons is colored red, determining that the left- or right-hand traffic division is left-hand traffic and the distance unit is a mile unit system; and
if the pair of vehicle icons are shown on the traffic sign and if the left vehicle icon of the pair of vehicle icons is colored red, determining that the left- or right-hand traffic division is right-hand traffic and the distance unit is a kilometer unit system.

6. A driving assistance system comprising:
an on-board imaging device that is mounted to an own vehicle and captures an image of a periphery of the own vehicle;
a sign recognizing apparatus that is mounted to an own vehicle, recognizes traffic signs including a no-passing sign from the image of the periphery of the own vehicle that has been captured by the on-board imaging device, and determines a left- or right-hand traffic division used in an area in which the no-passing sign is set and a distance unit used in the traffic sign, based on predetermined features of the no-passing sign included in the recognized traffic signs; and
a driving assistance executing unit that is mounted to the own vehicle and executes driving assistance by controlling a controlled device mounted to the own vehicle, based on the traffic signs, the left- or right-hand traffic division, and the distance unit recognized by the sign recognizing apparatus.

7. The driving assistance system according to claim 6, wherein
the sign recognizing apparatus is configured to:
use, as the predetermined features of the no-passing sign, at least whether or not a traversing line that traverses the traffic sign at an angle is present in the traffic sign; and
determine that, if the traversing line is present, the left- or right-hand traffic division is left-hand traffic and the distance unit is a kilometer unit system.

8. The driving assistance system according to claim 6, wherein
the sign recognizing apparatus is configured to:
use, as the predetermined features of the no-passing sign, at least a color of a pair of vehicle icons are shown on the traffic sign, the pair of vehicle icons being configured by: a left vehicle icon positioned on a left side in the traffic sign; and a right vehicle icon that is positioned on a right side in the traffic sign;
determine that, if the right vehicle icon of the pair of vehicle icons is colored red, the left- or right-hand traffic division is left-hand traffic and the distance unit is a mile unit system; and
determine that, if the left vehicle icon of the pair of vehicle icons is colored red, the left- or right-hand traffic division is right-hand traffic and the distance unit is a kilometer unit system.

9. The driving assistance system according to claim 7, wherein
the sign recognizing apparatus is configured to:
use, as the predetermined features of the no-passing sign, at least a color of a pair of vehicle icons are shown on the traffic sign, the pair of vehicle icons being configured by: a left vehicle icon positioned on a left side in the traffic sign; and a right vehicle icon that is positioned on a right side in the traffic sign;
determine that, if the right vehicle icon of the pair of vehicle icons is colored red, the left- or right-hand traffic division is left-hand traffic and the distance unit is a mile unit system; and
determine that, if the left vehicle icon of the pair of vehicle icons is colored red, the left- or right-hand traffic division is right-hand traffic and the distance unit is a kilometer unit system.
